(19) United States
(12) Patent Application Publication
(10) Pub. No.: US 2026/0281550 A1
(43) Pub. Date: Sep. 17, 2026

(54) Level Lock Mode on Camera

(71) Applicant: Google LLC, Mountain View, CA (US)

(72) Inventors: Kun Wang, San Jose, CA (US); Li Wei, Mountain View, CA (US); Wei Hong, Sunnyvale, CA (US); Fuhao Shi, San Jose, CA (US)

(21) Appl. No.: 19/474,334

(22) PCT Filed: Apr. 13, 2023
(86) PCT No.: PCT/US2023/018519

§ 371 Date: Oct. 10, 2025

(51) Int. Cl. H04N 23/68; H04N 23/63

(52) U.S. Cl. CPC H04N 23/682; H04N 23/632

(57) ABSTRACT

A method includes inferring a user intent to capture a level image based on user positioning of a camera. Based on the inferred user intent, the method includes causing a viewfinder to enter a level-lock mode, wherein the level-lock mode comprises displaying a preview level image in the viewfinder, wherein the preview level image is rotated based on an orientation of the camera relative to a level orientation. The method further includes receiving a signal indicating to capture an image. Based on the viewfinder being in the level-lock mode, the method includes providing a captured level image, wherein the captured level image is rotated based on the orientation of the camera relative to the level orientation.

### BACKGROUND

When capturing an image of a scene with a camera, such as a camera of a mobile phone, it may be desirable to capture a level photo. A leveling guide may provide a visual indicator of how to level the camera in order to capture such a photo. However, even with a leveling guide, it may be difficult for a user to maintain a level position throughout the process of capturing an image. Resulting photos of the scene may therefore be suboptimal.

### SUMMARY

Example systems and methods described herein enable the capture of level images through the use of a level-lock mode. While a viewfinder of the camera is active, it may be inferred that a user intends to capture a level image, for instance, based on user positioning of the camera. When this user intent is detected, the viewfinder may enter the level-lock mode. In the level-lock mode, a preview image may be rotated to a level position even if the camera is not perfectly level. A preview level image may therefore be displayed to a user. When an image is then captured while the viewfinder is in the level-lock mode, the resulting captured image may also be rotated to a level position and provided to a user as a captured level image.

In an embodiment, a method is disclosed which includes inferring a user intent to capture a level image based on user positioning of a camera. Based on the inferred user intent, the method includes causing a viewfinder to enter a level-lock mode, wherein the level-lock mode comprises displaying a preview level image in the viewfinder, wherein the preview level image is rotated based on an orientation of the camera relative to a level orientation. The method further includes receiving a signal indicating to capture an image. Based on the viewfinder being in the level-lock mode, the method includes providing a captured level image, wherein the captured level image is rotated based on the orientation of the camera relative to the level orientation.

In a further embodiment, a computing device is disclosed which is configured to infer a user intent to capture a level image based on user positioning of a camera. Based on the inferred user intent, the computing device is configured to cause a viewfinder to enter a level-lock mode, wherein the level-lock mode comprises displaying a preview level image in the viewfinder, wherein the preview level image is rotated based on an orientation of the camera relative to a level orientation. The computing device is further configured to receive a signal indicating to capture an image. Based on the viewfinder being in the level-lock mode, the computing device is configured to provide a captured level image, wherein the captured level image is rotated based on the orientation of the camera relative to the level orientation.

In another embodiment, one or more non-transitory computer readable media storing program instructions are disclosed which are executable by one or more processors to perform operations. The operations include inferring a user intent to capture a level image based on user positioning of a camera. Based on the inferred user intent, the operations include causing a viewfinder to enter a level-lock mode, wherein the level-lock mode comprises displaying a preview level image in the viewfinder, wherein the preview level image is rotated based on an orientation of the camera relative to a level orientation. The operations further include receiving a signal indicating to capture an image. Based on the viewfinder being in the level-lock mode, the operations include providing a captured level image, wherein the captured level image is rotated based on the orientation of the camera relative to the level orientation.

In a further embodiment, a system is provided that includes means for inferring a user intent to capture a level image based on user positioning of a camera. Based on the inferred user intent, the system includes means for causing a viewfinder to enter a level-lock mode, wherein the level-lock mode comprises displaying a preview level image in the viewfinder, wherein the preview level image is rotated based on an orientation of the camera relative to a level orientation. The system further includes means for receiving a signal indicating to capture an image. Based on the viewfinder being in the level-lock mode, the system includes means for providing a captured level image, wherein the captured level image is rotated based on the orientation of the camera relative to the level orientation.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an example image capturing device, in accordance with example embodiments.

FIG. 2 is a simplified block diagram showing some of the components of an example image capturing device, in accordance with example embodiments.

FIG. 3 is a diagram illustrating potential issues with image capture of level images, in accordance with example embodiments.

FIG. 4 is a block diagram illustrating a level-lock pipeline, in accordance with example embodiments.

FIG. 5 illustrates rotation of an image to a level position, in accordance with example embodiments.

FIG. 6 is a flowchart of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

Camera users may experience difficulty when trying to take level photos. There are a number of potential causes of such difficulty. One possible cause is that it may be difficult to find a reference horizon in certain scenes. Another possible cause is that the camera holder (for instance, a human hand or a tripod) may not be capable of maintaining a level position. A human hand in particular (especially a single hand) is difficult to hold perfectly steady at a level position. Due to subtle hand movement, the camera position can go off level by a small amount easily (e.g., one or two degrees), making it hard to capture a perfectly level photo. An additional cause of difficulty in capturing level photos is that an external force (e.g., shaking of the camera or pressing of a button) may cause subtle camera movements. In particular, when a user presses the shutter of a camera to take a shot, the force applied on the shutter button often moves the camera position slightly, which causes the framing of the shutter shot to become crooked.

Some techniques that would help a user obtain a level image require some degree of particular operation of the camera by the user. For instance, the user may be required to set up and apply extra external devices, such as a tripod, a mechanical stabilizer, or a leveled platform/support. Other techniques may involve displayed graphical position hints to guide the user to find the level position. However, in such circumstances, the user may be physically limited in the ability to maintain a level position for a period of time.

Other techniques may help reduce the effect of external forces which disrupt image quality. For instance, built-in image stabilization and/or vibration reduction hardware may be used, such as optical image stabilization (OIS) or in-body image stabilization (IBIS). Additionally, software algorithms may be run to stabilize image frames, such as electronic image stabilization (EIS). However, such techniques cannot guarantee the capture of level images.

Other techniques may involve adjusting the photos in post-processing. For instance, algorithms may be used to find or predict a level angle and rotate the photo accordingly. An image can also be rotated automatically or manually during image editing. However, such techniques may be imprecise and will not provide a user with an accurate preview of the resulting image before image capture.

Examples described herein may include two aspects to enable the capture of level images. In the first aspect, when it can be inferred that a user intends to capture a level image, a preview level image may be displayed in a viewfinder before image capture. Sensor data (e.g., sensor data from a gravity sensor and a gyroscope) may be used to determine the rotation angle of each preview image frame so that the image frame can be rotated to a level position (e.g., by using a warp mesh). Additionally, a user interface may be provided which clearly indicates if the current preview image frame is leveled and the viewfinder is in a level-lock mode (e.g., through the display of a graphical lock icon). Level-locking the preview image in the viewfinder may help to address issues related to imperfect hand stabilization while positioning a camera before image capture.

In the second aspect, when a signal is received indicating to capture an image (e.g., when a user presses the shutter or the shutter is triggered automatically) while the viewfinder is in the level-lock mode, the resulting captured image frame may be rotated to a level position. Rotating the captured image to a level position may help to address issues related to external force on the camera during image capture disrupting the level position. In addition, by rotating the resulting captured image as well as the preview image in the viewfinder, an accurate prediction of the resulting final image may be provided to the user.

Some examples described herein involve a mobile computing device, such as a mobile phone, which contains a camera which may be difficult to hold at a level position. Other examples may involve standalone cameras. Yet further examples may involve remote cameras, for instance ambient computing environments where cameras are operated by other communicatively connected devices. In such examples, a connected device may receive inputs to position a camera to capture level images (e.g., user interface inputs or physical movements which are mapped to camera movements). A viewfinder with a level-lock mode may therefore be displayed on a device containing a camera and/or on a device communicating with a remote camera.

### II. Example Systems and Methods

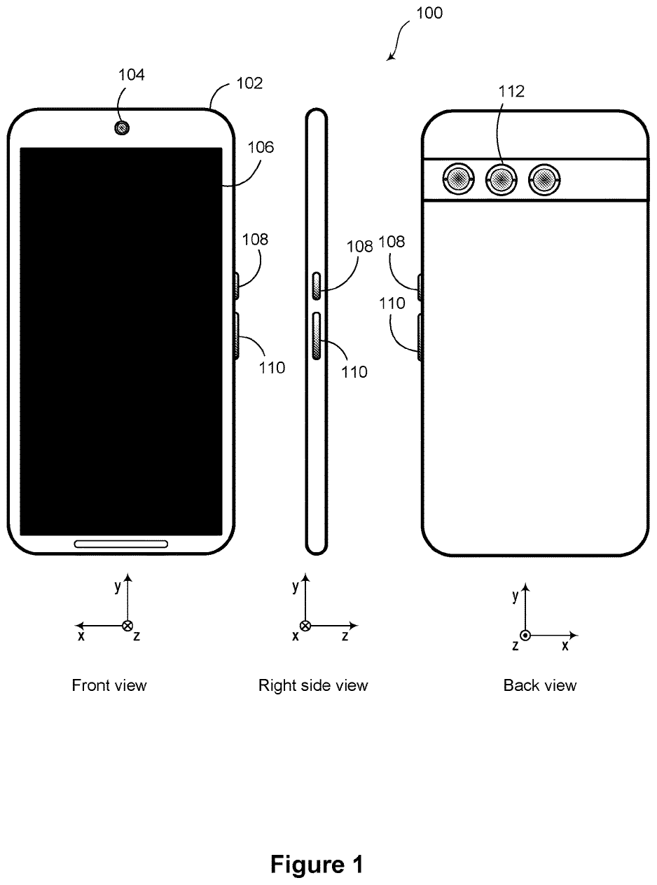

FIG. 1 illustrates an example computing device 100. In examples described herein, computing device 100 may be an image capturing device and/or a video capturing device. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and at least one rear-facing camera 112. In examples with multiple rear-facing cameras such as illustrated in FIG. 1, each of the rear-facing cameras may have a different field of view. For example, the rear facing cameras may include a wide angle camera, a main camera, and a telephoto camera. The wide angle camera may capture a larger portion of the environment compared to the main camera and the telephoto camera, and the telephoto camera may capture more detailed images of a smaller portion of the environment compared to the main camera and the wide angle camera.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

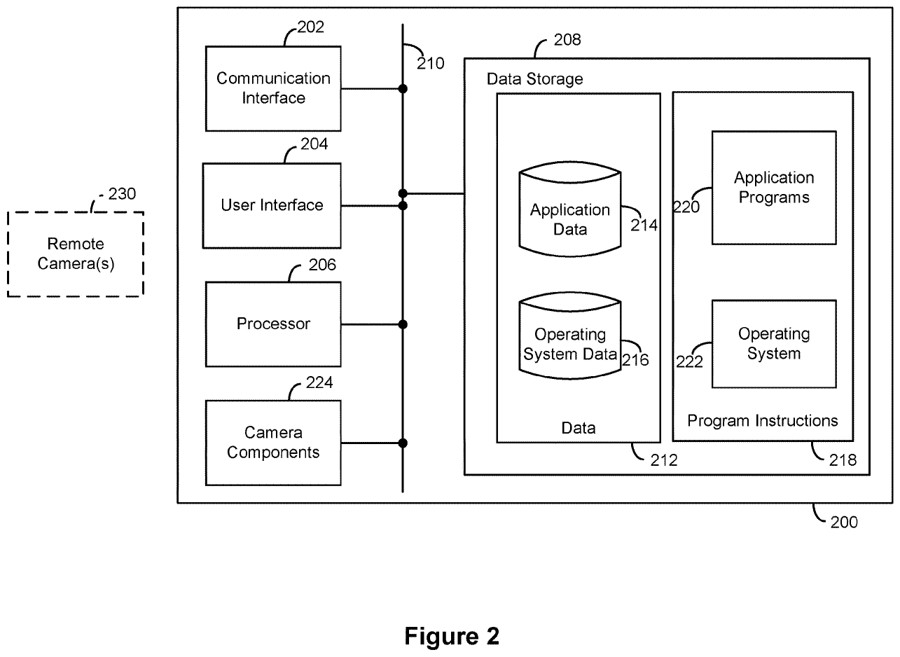

FIG. 2 is a simplified block diagram showing some of the components of an example computing system 200, such as an image capturing device and/or a video capturing device. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors-e.g., microprocessors- and/or one or more special purpose processors-e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

In further examples, one or more remote cameras 230 may be controlled by computing system 200. For instance, computing system 200 may transmit control signals to the one or more remote cameras 230 through a wireless or wired connection. Such signals may be transmitted as part of an ambient computing environment. In such examples, inputs received at the computing system 200 (for instance, physical movements of a wearable device) may be mapped to movements or other functions of the one or more remote cameras 230. Images captured by the one or more remote cameras 230 may be transmitted to the computing system 200 for further processing. Such images may be treated as images captured by cameras physically located on the computing system 200.

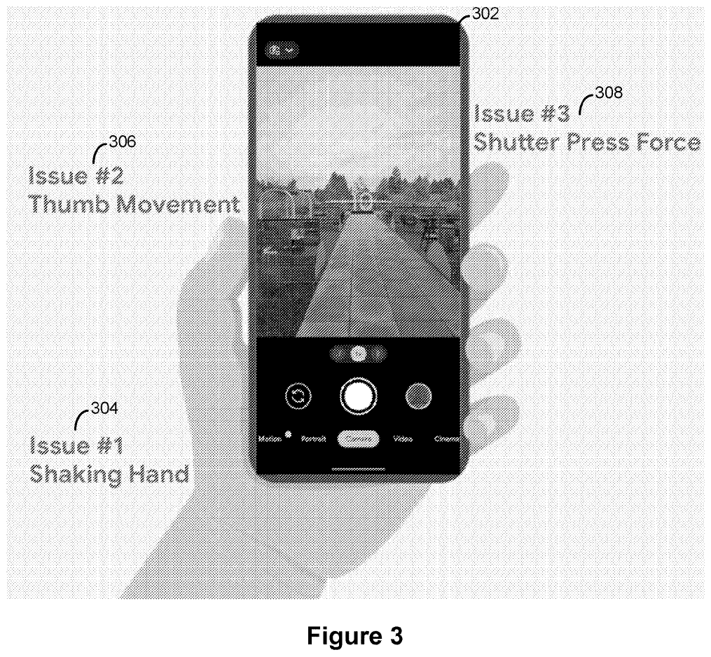

FIG. 3 is a diagram illustrating potential issues with image capture of level images, in accordance with example embodiments. More specifically, a hand of a user is illustrated positioning a phone 302 which includes a camera with a viewfinder. The viewfinder may include leveling guides to help guide the user to position the phone 302 so that the camera captures level images. In particular, the leveling guides may provide hints for how to rotate the phone 302 into a vertical position. However, it may be difficult for the user to maintain the phone 302 in a vertical position (and the camera in a level position) throughout the process of capturing an image with the camera.

In particular, issue 304 illustrates that a user's hand may shake while holding the phone 302, particularly while trying to position the phone 302 while viewing the preview image in the viewfinder. Hand shaking may cause rotations of the phone 302 from vertical, which may result in the capture of an image which is not level. Additionally, issue 306 illustrates that thumb movements by the user while holding phone 302 may disrupt the level position of the camera. In particular, thumb movements may cause slight clockwise or counterclockwise rotation of the phone 302, resulting in the capture of an image which is not level. Furthermore, issue 308 illustrates that shutter press force while capturing an image may also cause the phone 302 and the associated camera to not maintain a level position during the image capture process itself. Collectively, issues 304, 306, and 308 may make it difficult for a user to preview and capture a level image with the camera of phone 302.

Examples described herein help to address these issues by providing a level-lock mode to generate level images both during image preview and image capture. During image preview, a photo viewfinder may be configured to display a user interface element to inform the user when the camera is locked at a level position. The preview image may be rotated so that the preview image is stabilized at a level angle. During post-processing, a rotation may also be applied to a captured image to level the photo and offset any motion resulting from external force during image capture.

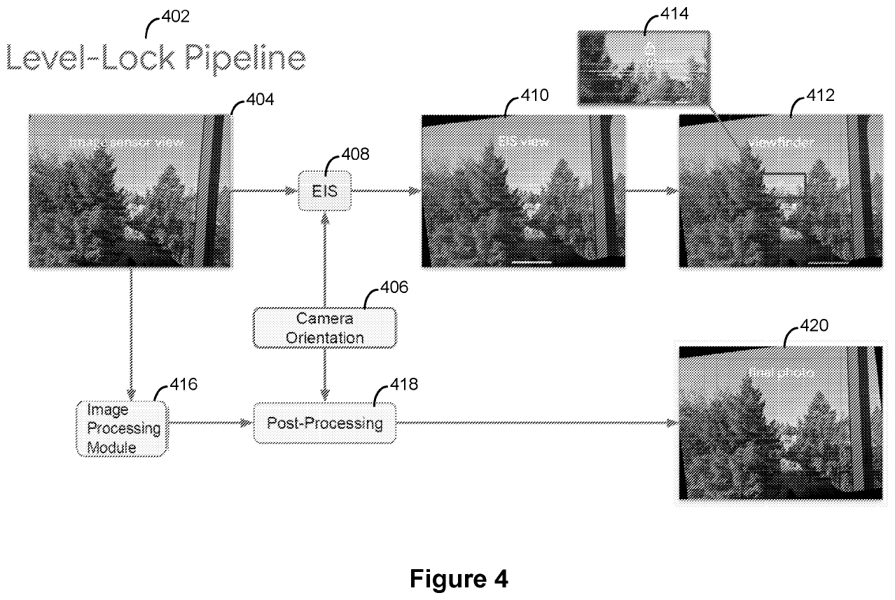

FIG. 4 is a block diagram illustrating a level-lock pipeline, in accordance with example embodiments. More specifically, level-lock pipeline 402 includes software and/or hardware components that facilitate the generation of preview and captured level images. Image sensor view 404 provides an image sensor view as captured by a camera before operation of the level-lock pipeline 402. In some examples, image sensor view 404 may be crooked despite a user intention to capture a level image.

In order to rotate image sensor view 404 to a level position, camera orientation data 406 may be received from one or more sensors. In some examples, camera orientation data 406 may include data from a gyroscope which indicates rotation of a camera around each of three axes. In addition, camera orientation data 406 may include data from a gravity sensor which includes a three dimensional vector indicating the direction and magnitude of gravity, which may be used as an indication of a level orientation. The camera orientation data 406 may be used to determine a camera's relative orientation in space. An angle between the orientation of the camera and gravity may be determined and used to determine how to rotate images to a level orientation. In further examples, other types of sensors may be used to generate camera orientation data 406 as well or instead.

During image preview before an image is captured, the image sensor view 404 and the camera orientation data 406 may be provided to EIS module 408 as part of a first processing pipeline. EIS module 408 may use software stabilization processes to stabilize image sensor view 404. When in level-lock mode, software processing by EIS module 408 may include at least rotating image sensor view 404 to a level position based on camera orientation data 406. EIS module 408 may therefore generate EIS view 410. As illustrated in FIG. 4, EIS view 410 is rotated based on a camera orientation data 406 to produce a level image. In some examples, the leveling angle applied by EIS module 408 may be gradually adapted (e.g., with fading in/out) to avoid large rotation changes in the preview image. In further examples, EIS module 408 may optionally perform additional image stabilization processes as well.

EIS view 410 may be used to generate viewfinder image 412 displayed by a viewfinder of the camera. Viewfinder image 412 may include a graphical indication 414 of an amount of rotation of the camera. When the viewfinder is in level-lock mode, the graphical indication 414 may show both that the previewed viewfinder image 412 is at a level position (at 0 degrees), and that the viewfinder image 412 is level-locked. In some examples, when entering level-lock mode, the amount of rotation may stop being displayed (e.g., a number of degrees may fade out) and may be replaced by a graphical lock icon. Because viewfinder image 412 is level-locked, small rotations of the camera will not cause the viewfinder image 412 to stray from a level position.

Although not illustrated in FIG. 4, viewfinder image 412 may additionally be zoomed in to eliminate the blank areas resulting from the rotation of the image sensor view 404. For instance, if the camera is rotated at 3 degrees while in level-lock mode, the field of view of the camera may be zoomed in by approximately 5% to eliminate the blank areas. In such examples, a small loss of field of view may be a satisfactory trade-off in exchange for a level image. In some examples, rotation and scaling of the image sensor view 404 may be performed using a warp mesh.

As part of a second processing pipeline, image sensor view 404 may also be provided to image processing module 416 which generates a captured image after a signal is received to capture an image. In some examples, image processing module 416 may be a high dynamic range image processing module, such as a high dynamic range plus (HDR+) module which captures several images with different exposure times in rapid succession to generate a high dynamic range captured image. The second processing pipeline may ensure that the image processing module output is leveled as well. More specifically, camera orientation data 406 may also be provided to post-processing module 418. Post-processing module 418 may apply a similar rotation as applied to the preview image to ensure that the final captured photo 420 is a level image. Although not illustrated in FIG. 4, the final captured photo 420 may also be zoomed in to remove the blank areas resulting from image rotation. For example, the same warp mesh which was applied in the first processing pipeline may also be applied to rotate and zoom the output image of image processing module 416 to generate the final captured photo 420.

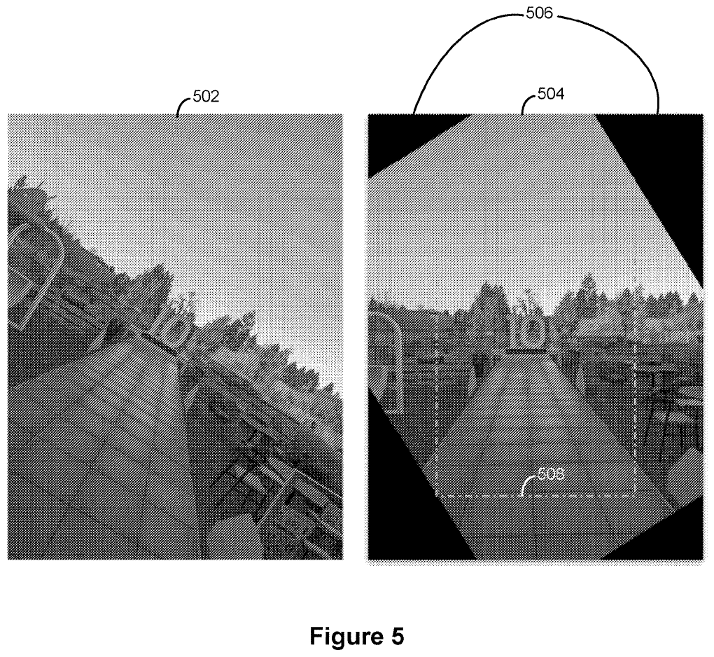

FIG. 5 illustrates rotation of an image to a level position, in accordance with example embodiments. More specifically, unrotated image 502 is rotated to produce level image 504. A large angle of rotation is used for illustration purposes. In practice, level-lock mode may only be entered if unrotated image 502 is within a threshold angle (e.g., 5 degrees) of a level position. In some examples, a user interface option may be provided to allow a user to manually force entry into level-lock mode regardless of the current angle of rotation. Such a user interface option may be advantageous if a user is located in an environment where maintaining a level image is particularly difficult (e.g., on a boat in heavy waves).

As illustrated in FIG. 5, the rotation of unrotated image 502 into level image 504 results in blank areas 506. In some examples, to avoid showing these blank areas 506 to the user, a smaller field of view 508 may be used. Accordingly, the preview image shown to the user may only be the portion of level image 504 which is located inside the field of view 508. In other examples, the full level image 504 including the blank areas 506 may be shown to the user during image preview to provide the user with an intuitive understanding of the field of view 508 which will ultimately be used for a resulting captured image. In such examples, a graphical indicator (e.g., a box) showing the reduced field of view 508 may also be displayed to the user during image preview.

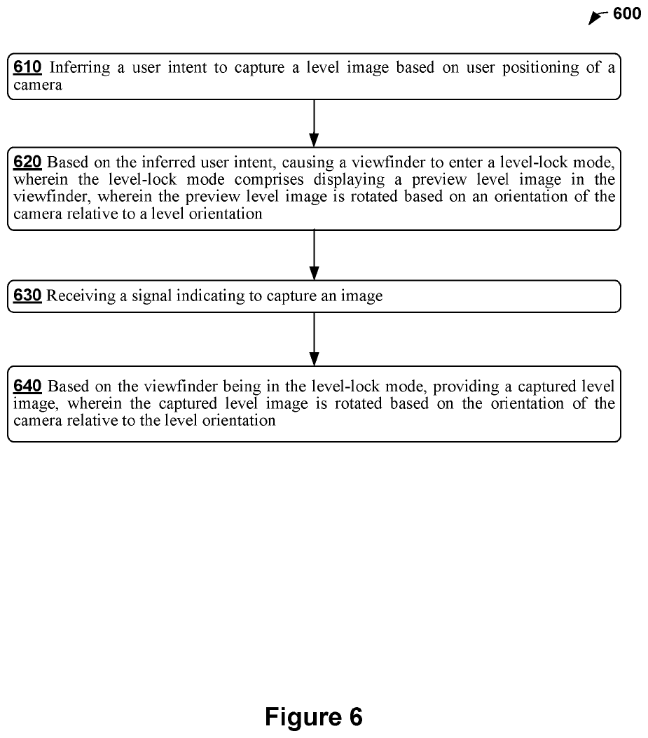

FIG. 6 is a flowchart of a method, in accordance with example embodiments. Method 600 of FIG. 6 may be executed by one or more computing systems (e.g., computing system 200 of FIG. 2) and/or one or more processors (e.g., processor 206 of FIG. 2). Method 600 may be carried out on a computing device, such as computing device 100 of FIG. 1. In some examples, each block of method 600 may be performed locally on a camera or an image capturing device which includes a camera (e.g., a smartphone). In alternative examples, a portion or all of the blocks of method 600 may be performed by one or more computing systems remote from a camera or image capturing device.

At block 610, method 600 includes inferring a user intent to capture a level image based on user positioning of a camera. In some examples, inferring the user intent is based on an angle difference between the orientation of the camera and the level orientation. In some examples, the orientation of the camera relative to the level orientation is determined based on sensor data from a gravity sensor and a gyroscope. In some examples, the angle difference between the orientation of the camera and the level orientation is compared to a threshold angle. In some such examples, the threshold angle may be equal to or less than five degrees. In some examples, inferring the user intent is based on an angle difference between the orientation of the camera and the level orientation being less than a threshold angle (e.g., 5 degrees) for at least a threshold amount of time (e.g., 3 seconds). By automatically entering the level-lock mode after a user attempts to stay in level position for some duration, less change of user behavior may be needed to enable entry into level-lock mode. When a user takes a level shot with a camera without level-lock mode, the user already spends time adjusting the camera. Accordingly, in a system with automatic entry into level-lock mode based on user positioning of the camera, the user may only need to hover near the level position a bit longer to trigger level-lock mode.

In some examples, inferring the user intent may be based on the contents of a scene captured by the camera as well or instead. In such examples, when the contents of the scene indicate that the scene is an environmental scene, it may be inferred that the user intends to capture a level image. On the other hand, when the contents of the scene indicate that the scene is a portrait (relatively close-up image of one or more people), it may be inferred that the user does not intend to capture a level image.

At block 620, method 600 includes causing a viewfinder to enter a level-lock mode based on the inferred user intent. The level-lock mode comprises displaying a preview level image in the viewfinder. The preview level image is rotated based on an orientation of the camera relative to a level orientation.

In some examples, the preview level image in the viewfinder is zoomed in to eliminate the display of blank areas resulting from rotation of the preview level image. In other examples, the preview level image in the viewfinder is displayed with blank areas resulting from rotation of the preview level image. In some such examples, the preview level image in the viewfinder includes a graphical indicator of a reduced field of view resulting from rotation of the preview level image.

At block 630, method 600 includes receiving a signal indicating to capture an image. In some examples, the signal may be received based on a user input (e.g., a shutter button press). In other examples, the shutter may be triggered automatically. In such examples, the shutter may be triggered automatically upon entering level-lock mode or a preset amount of time after entering level-lock mode.

At block 640, method 600 includes providing a captured level image based on the viewfinder being in the level-lock mode. The captured level image is rotated based on the orientation of the camera relative to the level orientation. In some examples, the preview level image is based on a first processing pipeline and the captured level image is based on a second processing pipeline. In such examples, the first processing pipeline and the second processing pipeline both receive a warp mesh for image rotation (and optionally image zooming as well).

Some examples of method 600 may be performed by an image capturing device which contains a camera. In such examples, the user positioning of the camera may be based on physical movement of a mobile computing device which comprises the camera. In such examples, the viewfinder may include an image which is displayed on a screen of the camera. Other examples of method 600 may be performed by a computing device remote from a camera. In such examples, the user positioning of the camera may be based on user input received at a computing device remote from the camera. In such examples, the viewfinder may include an image which is displayed on the computing device remote from the camera as well as or instead of the camera itself.

Method 600 may further include causing the viewfinder to exit the level-lock mode. In some examples, exiting the level-lock mode may be based on an angle difference between the orientation of the camera and the level orientation being above a threshold angle. In some such examples, the threshold angle used to exit level-lock mode may be the same as the threshold angle used to enter level-lock mode. In other examples, the threshold angle used to exit the level-lock mode is a second threshold angle greater than the first threshold angle used for entering the level-lock mode. For instance, the first threshold angle may be 5 degrees and the second threshold angle may be 10 degrees.

More generally, a computing system may cause the viewfinder to exit the level-lock mode when the computing system infers that the user no longer intends to capture a level image. A computing system may look for one or more clues to indicate this user intent. The one or more clues may include large movement of an image capturing device, either the pitch or roll angle of the image capturing device no longer being near the leveled position, and/or that image capture of a level image occurred while in level-lock mode. In further examples, the viewfinder may exit the level-lock mode based on user selection of a manual override option.

### III. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

1. A method comprising:
inferring a user intent to capture a level image based on user positioning of a camera;
based on the inferred user intent, causing a viewfinder to enter a level-lock mode, wherein the level-lock mode comprises displaying a preview level image in the viewfinder, wherein the preview level image is rotated based on an orientation of the camera relative to a level orientation;
receiving a signal indicating to capture an image; and
based on the viewfinder being in the level-lock mode, providing a captured level image, wherein the captured level image is rotated based on the orientation of the camera relative to the level orientation.

2. The method of claim 1, wherein inferring the user intent is based on an angle difference between the orientation of the camera and the level orientation being less than a threshold angle.

3. The method of claim 2, wherein the threshold angle is equal to or less than five degrees.

4. The method of claim 1, wherein inferring the user intent is based on an angle difference between the orientation of the camera and the level orientation being less than a threshold angle for at least a threshold amount of time.

5. The method of claim 1, wherein inferring the user intent is based on contents of a scene captured by the camera.

6. The method of claim 5, wherein inferring the user intent is based on the contents of the scene indicating that the scene is an environmental scene.

7. The method of claim 5, wherein inferring the user intent is based on the contents of the scene indicating that the scene is not a portrait.

8. The method of claim 1, wherein the preview level image in the viewfinder is zoomed in to eliminate display of blank areas resulting from rotation of the preview level image.

9. The method of claim 1, wherein the preview level image in the viewfinder is displayed with blank areas resulting from rotation of the preview level image.

10. The method of claim 9, wherein the preview level image in the viewfinder includes a graphical indicator of a reduced field of view resulting from rotation of the preview level image.

11. The method of claim 1, further comprising causing the viewfinder to exit the level-lock mode based on an angle difference between the orientation of the camera and the level orientation being above a threshold angle.

12. The method of claim 11, wherein the threshold angle is a second threshold angle greater than a first threshold angle, wherein the viewfinder enters the level-lock mode based on the angle difference between the orientation of the camera and the level orientation being below the first threshold angle.

13. The method of claim 1, further comprising causing the viewfinder to exit the level-lock mode based on user selection of a manual override option.

14. The method of claim 1, wherein the preview level image is based on a first processing pipeline and the captured level image is based on a second processing pipeline.

15. The method of claim 14, wherein the first processing pipeline and the second processing pipeline both receive a warp mesh for image rotation.

16. The method of claim 1, wherein the orientation of the camera relative to the level orientation is determined based on sensor data from a gravity sensor and a gyroscope.

17. The method of claim 1, wherein the user positioning of the camera is based on physical movement of a mobile computing device which comprises the camera.

18. The method of claim 1, wherein the user positioning of the camera is based on user input received at a computing device remote from the camera, wherein the viewfinder is displayed on the computing device remote from the camera.

19. A computing device comprising configured to:
infer a user intent to capture a level image based on user positioning of a camera;
based on the inferred user intent, cause a viewfinder to enter a level-lock mode, wherein the level-lock mode comprises displaying a preview level image in the viewfinder, wherein the preview level image is rotated based on an orientation of the camera relative to a level orientation;
receive a signal indicating to capture an image; and
based on the viewfinder being in the level-lock mode, provide a captured level image, wherein the captured level image is rotated based on the orientation of the camera relative to the level orientation.

20. One or more non-transitory computer readable media comprising program instructions executable by at least one processor to perform operations comprising:
inferring a user intent to capture a level image based on user positioning of a camera;
based on the inferred user intent, causing a viewfinder to enter a level-lock mode, wherein the level-lock mode comprises displaying a preview level image in the viewfinder, wherein the preview level image is rotated based on an orientation of the camera relative to a level orientation;
receiving a signal indicating to capture an image; and
based on the viewfinder being in the level-lock mode, providing a captured level image, wherein the captured level image is rotated based on the orientation of the camera relative to the level orientation.
